(19) United States
(12) Patent Application Publication
(10) Pub. No.: US 2007/0202473 A1
(43) Pub. Date: Aug. 30, 2007

(54) Simulation system, simulation apparatus, image forming apparatus, simulation method and program

(75) Inventors: Yutaka Koda, Saitama-shi (JP); Takeshi Yokoe, Saitama-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Minato-ku (JP)

(21) Appl. No.: 11/517,265

(22) Filed: Sep. 8, 2006

(30) Foreign Application Priority Data
Feb. 28, 2006 (JP) 2006-052116
Apr. 5, 2006 (JP) 2006-104448

(51) Int. Cl. G09B 19/00

(52) U.S. Cl. 434/118

(57) ABSTRACT

A simulation apparatus simulates a process executed by an image forming apparatus. The simulation apparatus includes a first acquiring unit, an image generating unit and a first output unit. The first acquiring unit acquires an image formation command comprising information of a target image. The image generating unit generates an image, which is expected to be output by the image forming apparatus, based on the acquired image formation command. The first output unit coverts the generated image into data in a predetermined format. The first output unit outputs the converted data.

### BACKGROUND OF THE INVENTION

### Technical Field

The invention relates to a simulation system, a simulation apparatus, an image forming apparatus, a simulation method and program, capable of executing a simulation of an image forming process in the image forming apparatus.

### SUMMARY

According to an aspect of the invention, a simulation apparatus simulates a process executed by an image forming apparatus. The simulation apparatus includes a first acquiring unit, an image generating unit and a first output unit. The first acquiring unit acquires an image formation command comprising information of a target image. The image generating unit generates an image, which is expected to be output by the image forming apparatus, based on the acquired image formation command. The first output unit coverts the generated image into data in a predetermined format. The first output unit outputs the converted data.

A program according another aspect of the invention may be stored in any computer-readable storage medium such as CD-ROM (Compact Disk-Read Only Memory), DVD-ROM (Digital Versatile Disk-Read Only Memory) of memory card.

### BRIEF DESCRIPTION OF THE DRAWINGS

Exemplary embodiments of invention will be described in detail based on the following figures, wherein:

FIG. 1 is a system configurative view of a simulation system according to a first exemplary embodiment of the invention;

FIG. 2 is a hardware configurative view of the simulation system;

FIG. 3 is a functional block diagram of the simulation system;

FIG. 4 is a view showing an example of an operation screen of an image forming apparatus;

FIG. 5 is a sequence diagram of a simulation process in the simulation system;

FIG. 6 is a general view showing a schematic configuration of a computer system containing a simulation apparatus for the image forming apparatus according to a second exemplary embodiment of the invention;

FIG. 7 is a functional block diagram showing functions of the simulation apparatus for the image forming apparatus according to the second exemplary embodiment;

FIG. 8 is a view showing an example of a printer select screen displayed on a user terminal;

FIG. 9 is a view showing an example of an expansion tray set screen displayed on the user terminal;

FIG. 10 is a view showing an example of a virtual feed information input screen displayed on the user terminal;

FIG. 11 is an explanatory view explaining an example of virtual feed information that the simulation apparatus for the image forming apparatus according to the second exemplary embodiment acquires;

FIG. 12 is a view showing an example of an operation panel screen displayed on the user terminal;

FIG. 13 is a view showing an example of a simulation result display screen displayed on the user terminal;

FIG. 14 is a flowchart showing an example of a process executed by the simulation apparatus for the image forming apparatus according to the second exemplary embodiment; and

FIG. 15 is a flowchart showing an example of a feed simulation process executed by the simulation apparatus for the image forming apparatus according to the second exemplary embodiment.

### DETAILED DESCRIPTION OF EXEMPLARY EMBODIMENTS

Hereinafter, exemplary embodiments of the invention will be described in detail with reference to accompanying drawings.

### First Exemplary Embodiment

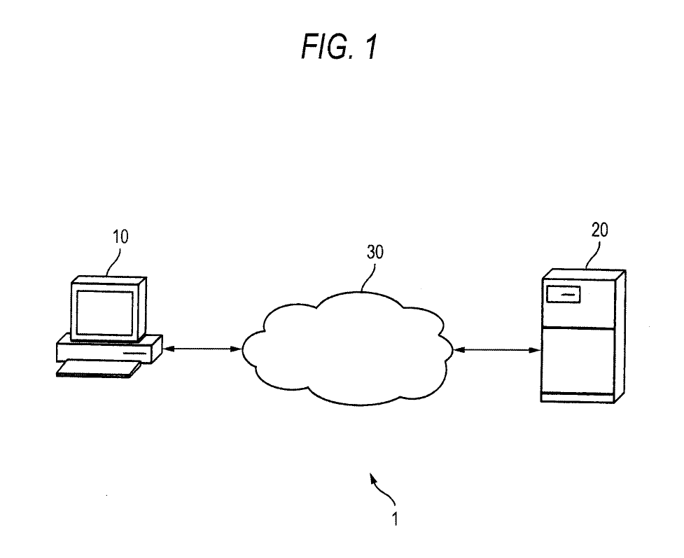

FIG. 1 shows a system configurative view of an overall simulation system according to a first exemplary embodiment of the invention. As shown in FIG. 1, a simulation system 1 is configured to include a client device 10 and a simulation apparatus 20 functioning as a server. The client device 10 and the simulation apparatus 20 are connected via a network 30 to communicate with each other. In this exemplary embodiment, it is assumed that the network 30 is made up of the Internet. However, this network 30 is not limited to the Internet, but may be the intranet such as LAN.

An outline of the simulation system 1 will be explained hereinbelow. The simulation apparatus 20 according to this exemplary embodiment of the invention also functions as the Web server. Also, when a user accesses the simulation apparatus 20 via a Web browser running on the client device 10, an operation screen of a printer, which is an object of simulation, is displayed on the Web browser of the client device 10. Also, the user inputs information specifying printing setting, printing data, etc. into the displayed operation screen, and then transmits the information to the simulation apparatus 20. The simulation apparatus 20 executes the simulation of the image processing based on the transmitted information, and generates an output image. Then, the simulation apparatus 20 transmits the output image generated as a simulation result to the client device 10. The client device 10 displays the transmitted output image by the Web browser. In this way, even if the user who operates the client device 10 does not actually possess the printer, such a user can cause the simulation apparatus 20 via the Internet to simulate an image formation made by a desired printer and can look at the simulation result.

In order to implement the above processes, an example of a configuration of the simulation system 1 according to the first exemplary embodiment of the invention will be explained hereinbelow.

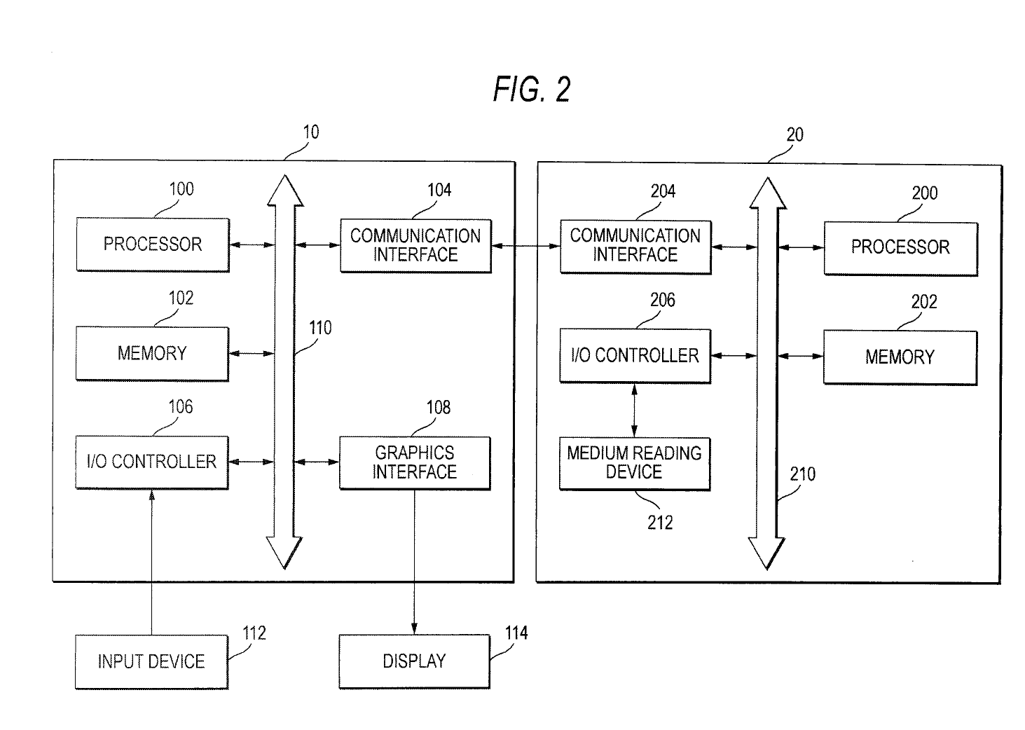

FIG. 2 is a view showing respective hardware configurations of the client device 10 and the simulation apparatus 20 included in the simulation system 1. The respective apparatuses will be explained below.

As shown in FIG. 2, the client device 10 includes a processor 100, a memory 102, a communication interface 104, an I/O controller 106 and a graphics interface 108 as physical configurations. The respective portions are connected via a bus 110 to communicate mutually.

The processor 100 controls the respective portions of the client device 10 based on an operating system stored in ROM or a hard disk (not shown) or a program read from the memory 102 or an information storing medium stored in a medium reading device (not shown). Also, the program and the data are loaded into the memory 102 if required, and this memory 102 is used as a working memory for the processor 100.

The communication interface 104 is an interface used in connecting to the network 30. The communication interface 104 may perform a cable communication or a radio communication. Also, the communication interface 104 may be one in conformity with the standard of the Ethernet (registered trademark).

The I/O controller 106 is a hardware that controls the input/output of data signals into/from the client device 10. In this exemplary embodiment, an input device 112 such as a keyboard or a mouse is connected to the I/O controller 106. The client device 10 receives information input from the user via the I/O controller 106.

The graphics interface 108 is configured to contain a video memory, and transfers image data formed in the video memory to a display 114. Also, an image is drawn on a screen of the display 114 based on the transferred image data. The display 114 may be composed of CRT or a liquid crystal display that is externally connected to the client device 10, or may be composed of a display that is contained in the same casing as the client device 10.

Next, a hardware configuration of the simulation apparatus 20 will be explained below. As shown in FIG. 2, the simulation apparatus 20 includes a processor 200, a memory 202, a communication interface 204, an I/O controller 206, and a medium reading device 212 as physical configurations. The respective portions are connected via a bus 210 to communicate mutually.

The processor 200 controls the respective portions of the simulation apparatus 20 based on an operating system stored in ROM or a hard disk (not shown) or a program read from the memory 202 or an information storing medium stored in a medium reading device 212. Also, the program and the data are loaded into the memory 202 if required, and this memory 202 is used as a working memory for the processor 200.

The communication interface 204 is an interface used in connecting to the network 30. The communication interface 204 may perform a cable communication or a radio communication. Also, the communication interface 204 may one in conformity with the standard of the Ethernet (registered trademark).

The I/O controller 206 is a hardware that controls the input/output of data signals into/from the client device 10. The medium reading device 212 is connected to the I/O controller 206. The medium reading device 212 receives the computer-readable information storing medium such as CD-ROM or DVD-ROM, and reads the program stored in the medium. The program read in this way is stored in the memory 202 via the I/O controller 206, and is executed by the processor 200.

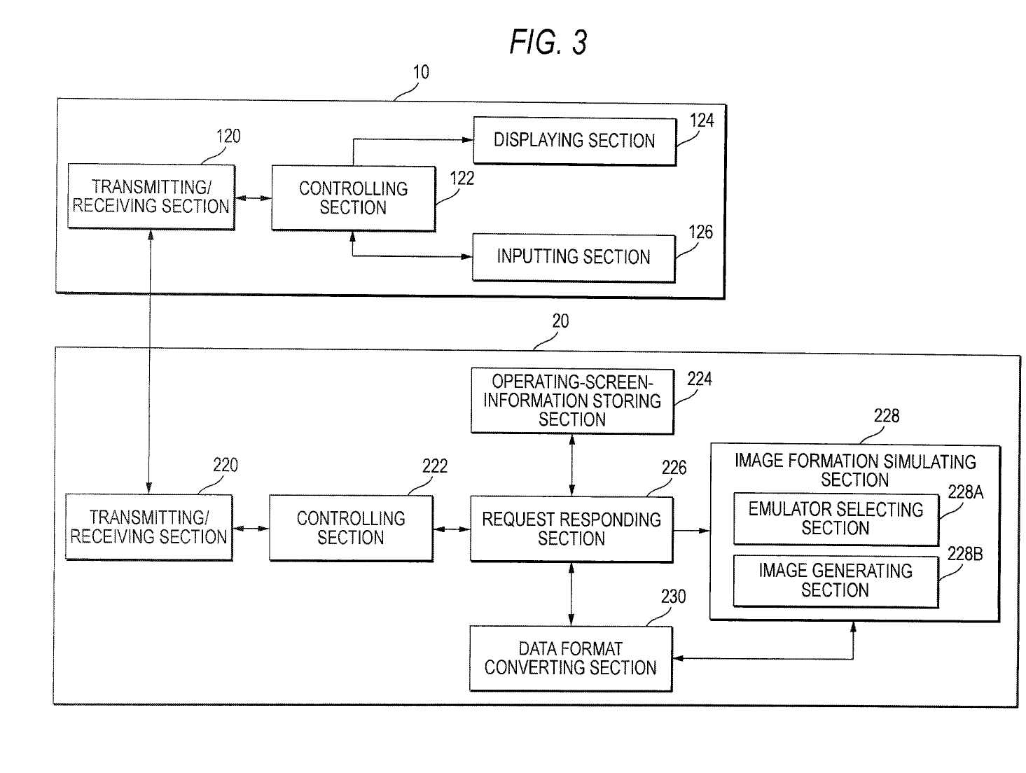

FIG. 3 shows a functional block diagram showing functions of the simulation system 1. The simulation system 1 includes the client device 10 and the simulation apparatus 20. Functions of the respective apparatuses will be explained below.

As shown in FIG. 3, the client device 10 includes a transmitting/receiving section 120, a controlling section 122, a displaying section 124 and an inputting section 126 as physical configurations. Details of the respective sections will be explained below.

The transmitting/receiving section 120 has a function of performing data communication. The transmitting/receiving section 120 is the function implemented by the communication interface 104 of the client device 10. In this exemplary embodiment, the client device 10 performs the data communication with the simulation apparatus 20 on the HTTP protocol with this transmitting/receiving section 120. Specifically, the transmitting/receiving section 120 transmits request data containing URL information and an image forming command, which are displayed by the Web browser of the client device 10, and receives a response to the request data from the simulation apparatus 20.

The controlling section 122 has a function of controlling physical operation of the hardware of the client device 10 to control the respective functions of the client device 10 and to control timing of processes executed by the respective functions. The controlling section 122 is the function implemented by the processor 100 of the client device 10, the memory 102, and the operating system.

The displaying section 124 has a function of visualizing information and displaying it. In this exemplary embodiment, the displaying section 124 is the function implemented by the display 114 and the Web browser running on the client device 10. The displaying section 124 accesses the simulation apparatus 20 functioning as the Web server and displays a virtual operation screen of the printer on the Web browser. The operation screen herein displays a simulated operation panel of the actual printer. Also, the displaying section 124 displays an output image output, which is output from the simulation apparatus as a simulation result.

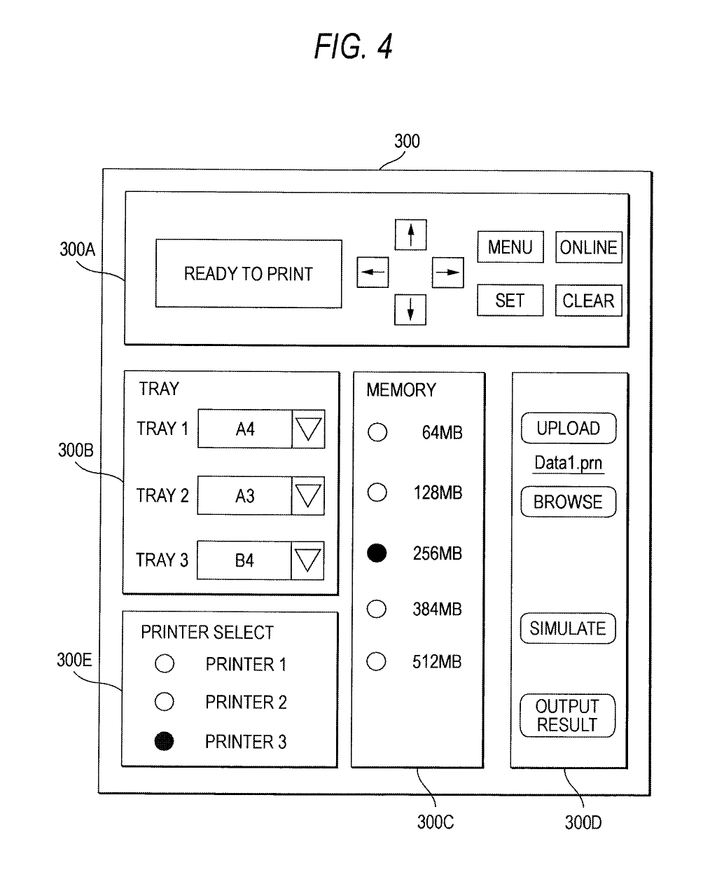

FIG. 4 shows an example of the operation screen displayed by the displaying section 124. FIG. 4 is a view showing an example of the operation screen in accordance with the image forming apparatus, which is the object of simulation. An operation screen 300 shown in FIG. 4 is displayed on the Web browser running on the client device 10, for example. Details of the operation screen 300 will be explained below.

The operation screen 300 shown in FIG. 4 includes an operation-panel display frame 300A, a paper specifying frame 300B, a memory specifying frame 300C, a file specifying frame 300D and a printer specifying frame 300E. The operation screen is not limited to that shown in FIG. 4, but may be another mode.

The operation-panel display frame 300A displays a simulated operation panel of the actual printer. The operation-panel display frame 300A Includes displaying of LCD/LED and displaying of buttons. The user can experience the operation of the operation panel of the printer in a simulated way. The paper specifying frame 300B is an input frame used to specify a paper size stored in a feed tray of the printer, which is the object of simulation. The memory specifying frame 300C is an input frame used to specify a memory capacity of the printer, which is the object of simulation. The file specifying frame 300D is an input frame used to specify print data, which is to be uploaded on the simulation apparatus 20. The file specifying frame 300D includes a “browse” button, a “simulate” button, and an “output result” button. The “browse” button is used to browse a file system of the client device 10 for the purpose of designating a path of the file uploaded on the simulation apparatus 20. The “simulate” button is used to instruct the simulation apparatus 20 to start simulation, which uses the data uploaded from the client device 10. The “output result” button is used to instruct the Web browser to display the simulation result. Also, the printer specifying frame 300E is an input frame used to input information specifying a model of the printer, which is the object of simulation.

The inputting section 126 has a function of accepting user's inputs of information. The inputting section 126 is the function implemented by the I/O controller 106 of the client device 10 and the input device 112 such as keyboard or mouse connected to the I/O controller 106. The inputting section 126 realizes inputting, of the information into an input box on the operation screen 300 shown in FIG. 4, for example.

Next, functions of the simulation apparatus 20 will be explained below. As shown in FIG. 3, the simulation apparatus 20 includes a transmitting/receiving section 220, a controlling section 222, an operating-screen-information storing section 224, a request responding section 226, an image formation simulating section 228 and a data format converting section 230 as functional configurations. Details of the respective sections will be explained below. These functions may be implemented when the program stored in the computer-readable information storing medium is read into the simulation apparatus 20, which is a computer system, with the medium reading device 212 and then is executed by this simulation apparatus 20.

The transmitting/receiving section 220 has a function of performing data communication. The transmitting/receiving section 220 is the function implemented by the communication interface 204 of the simulation apparatus 20. In this exemplary embodiment, the transmitting/receiving section 220 performs the data communication with the client device 10 on the HTTP protocol using this transmitting/receiving section 220. Specifically, the transmitting/receiving section 220 receives request data containing URL information and form data (information such as print parameters, print data, etc. input through the operation screen 300), which are displayed on the client device 10, and transmits a response to the request data.

The controlling section 222 has a function of controlling the operation of the physical hardware of the simulation apparatus 20 to control the respective functions of the simulation apparatus 20 and control timings of processes executed by the respective functions. The controlling section 222 is the function implemented by the processor 200 of the simulation apparatus 20, the memory 202, and the operating system.

The operating-screen-information storing section 224 has a function of storing data indicating the operation screens, which correspond to respective printers, which are objects of simulation. The operating-screen-information storing section 224 may be provided as either a function implemented by the memory 202 of the simulation apparatus 20 or the function implemented by a recording medium that can be read by the medium reading device 212. The data indicating the operation screen may be described in HTML. In such a case, the operation screen of the printer is displayed on the Web browser based on the HTML data indicating the operation screen.

The request responding section 226 has a function of executing a process in accordance with the request from the client device 10 and offering a response based on the process result. When the simulation apparatus 20 receives from the client device 10 an access requesting the display of the operation screen, the request responding section 226 acquires HTML data to display the requested operation screen from the operating-screen-information storing section 224 and sends a reply. Also, when the simulation apparatus 20 receives from the client device 10 an access requesting the simulation of image formation, the request responding section 226 executes the simulation of image formation based on the received information and replies the result. The request responding section 226 is implemented by the hardware of the simulation apparatus 20 as follows.

When the request received via the communication interface 204 points URL by the GET method of HTTP, the processor 200 of the simulation apparatus 20 reads from the memory 202 the HTML data (data indicated by the operation screen of the printer) indicated by the URL designated by this request. Then, the simulation apparatus 20 sends back the read data to the client device 10. Also, when the received request is in the POST method of HTTP and contains form data of the operation screen, the processor 200 executes the simulation of image formation by the printer based on the received request. This simulation of image formation is executed by the image formation simulating section 228. Then, the simulation apparatus 20 sends back the simulation result to the client device 10.

The image formation simulating section 228 has a function of simulating formation of an expected image, which the image forming apparatus as the object of simulation is expected to output when acquiring an image forming command, based on the image forming command received from the client device 10. The image formation simulating section 228 includes an emulator selecting section 228A and an image generating section 228B. Functions of the respective sections 228A and 228B will be explained below.

Also, in this exemplary embodiment, it is assumed that a printer emulator for implementing image processing executed by each printer in a software manner is prepared for each printer. The printer emulator is a program that is read into the memory 202 and executed by the processor 200.

The emulator selecting section 228A has a function of selecting the printer emulator corresponding to a type of the image forming apparatus indicated by model specifying information, which is contained in the image forming command received from the client device 10 and specifies the model of the image forming apparatus. The emulator selecting section 228A is implemented by the hardware of the simulation apparatus 20 as follows. The simulation apparatus 20 stores the printer emulator for a model of the printer in association with model specifying information that specifies the model of the printer. Here, the model specifying information may be given by the model name of the printer or may be given by identification information that is associated with each model. Also, the printer emulator and the association information may be stored in information recording medium that is readable by the medium reading device 212 or ROM (not shown). Also, the processor 200 of the simulation apparatus 20 acquires the model specifying information contained in form data (information designated by the printer specification frame 300E shown in FIG. 4) by referring to the form data received via the communication interface 204. Also, the processor 200 selects a printer emulator based on the acquired model specifying information.

The image generating section 228B has a function of processing the received image forming command by using the printer emulator selected by the emulator selecting section 228A, and a function of generating an output image. The image generating section 228B is implemented by the hardware of the simulation apparatus 20 as follows. The processor 200 of the simulation apparatus 20 reads print parameters and paper specifying information, which are contained in the form data transmitted from the client device 10, based on the program of the selected printer emulator. Then, the processor 200 applies language analysis to print data, which is described in PDL and contained in the image forming command. If any error occurs during the analysis, the processor 200 outputs error information. The error information output here may be transmitted to the client device 10. This error information may be displayed on the Web browser of the client device 10. Also, when the error does not occur during the analysis, the processor 200 executes the drawing process based on the read print parameters and the print data to generate the output image.

The data format converting section 230 has a function of converting the output image generated by the processor 200 into data in a predetermined format. In the data format converting section 230, the image generated by the image generating section 228B (e.g., bit map data) may be converted into data in another format such as JPEG or TIFF, whose file size is smaller, for example. By doing so, a quantity of data transferred on the network 30 that connects the client device 10 and the simulation apparatus 20 can be reduced. Of course, the data format is not limited to the above data format cited as an example, and another data format, which depends on a user's environment, may be employed.

Also, the simulation apparatus 20 may transmit on the HTTP protocol the generated image data to the client device 10 as the simulation result. Also, the simulation apparatus 20 may upload the generated image to the Web server and may inform the client device 10 of URL via which the image can be downloaded. In this case, the image may be downloaded by using the HTTP or the FTP.

Detailed operations of the simulation process of the image formation in the simulation system 1 according to the first exemplary embodiment of the invention will be explained below.

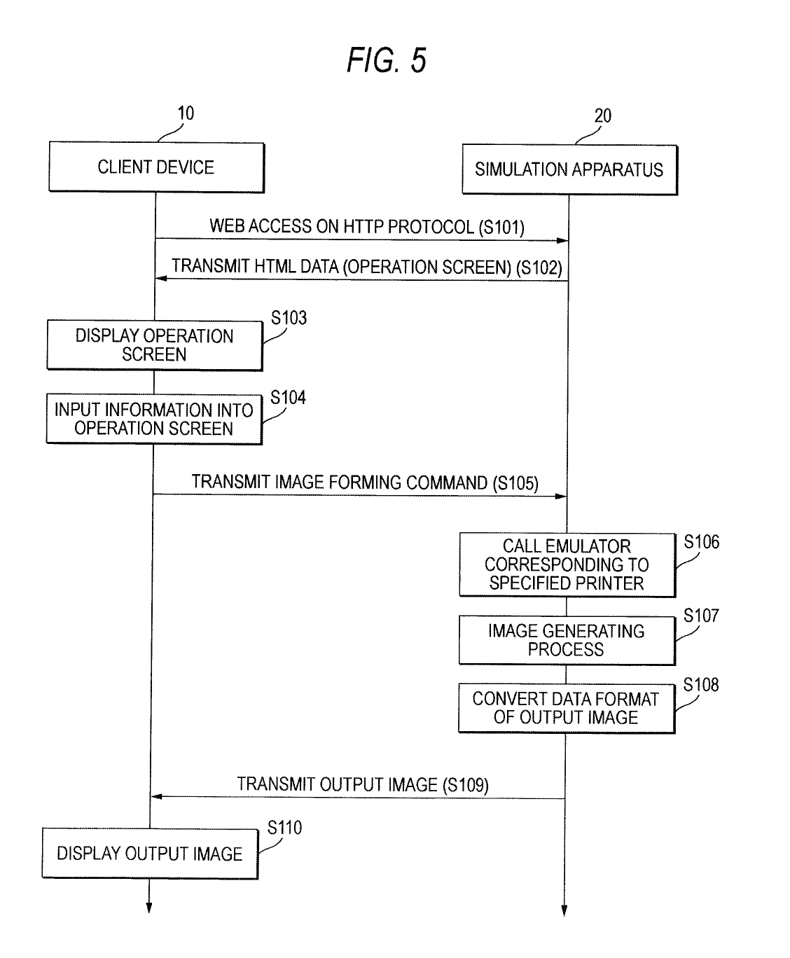

FIG. 5 shows a sequence diagram of the simulation process of the image formation in the simulation system 1. As shown in FIG. 5, in the simulation system 1, the client device 10 and the simulation apparatus 20 carry on the simulation process while exchanging the message mutually.

First, the client device 10 designates UPL on the Web browser to access the simulation apparatus 20 on the HTTP protocol (S101). The simulation apparatus 20 transmits the HTML data, which is used to display an operation screen of a printer corresponding to the accessed URL, to the client device 10 (S102). Then, the client device 10 receives the HTML data and displays the operation screen of the printer on the Web browser based on the received HTML data (S103).

Information including information for specifying print data, which is an object of simulation, information for specifying a printer and print setting information regarding image formation are input into the displayed operation screen of the client device 10 (S104). Then, when an instruction for the simulation start is given to the client device 10, the client device 10 transmits form data including the information, which are input into the operation screen (containing an image forming command) to the simulation apparatus 20 (S105).

The simulation apparatus 20 receives the image forming command. Then, the simulation apparatus 20 refers to model specifying information included in the received image forming command, to call an emulator corresponding to the specified printer (S106). The simulation apparatus 20 generates the output image based on the received image forming command with the called printer emulator (S107). Then, the simulation apparatus 20 converts the generated image into a predetermined data format such as JPG (S108). Then, the simulation apparatus 20 transmits the finally generated image data to the client device 10 (S109).

The client device 10 receives the image data generated as the simulation result of the image formation from the simulation apparatus 20. Then, the client device 10 displays the received image data on the Web browser (S110).

In this case, the invention is not limited to the above exemplary embodiment.

For example, the simulation system 1 may be modified as follows.

A printer driver may be installed into the client device 10. Then, an output of the installed printer driver is set to a network port of the simulation apparatus 20. In this manner, a printing command is issued from an application software running on the client device 10, the printer driver outputs print data including a combination of a job control language and a printer language based on application data, and then transmits the print data to the simulation apparatus 20. In this manner, the simulation apparatus 20 may execute the simulation process by using the print data transmitted from the client device 10 to the simulation apparatus 20.

Alternately, in the above modification, the application data may be transmitted from the client device 10 to the simulation apparatus 20, and then the simulation apparatus 20 may generate the print data based on the application data and execute the simulation process.

Also, in the first exemplary embodiment, in the simulation system 1, the client device 10 and the simulation apparatus 20 are realized by separate casings. However, the invention is not limited to this, and the simulation system 1 may be realized by a single casing.

Also, in the first exemplary embodiment, a function as the Web server and a function as the application server that executes the simulation process are realized in a single casing of the simulation apparatus 20. However, the invention is not limited to this, and the functions of the Web server and the application server may be realized by separate casings.

### Second Exemplary Embodiment

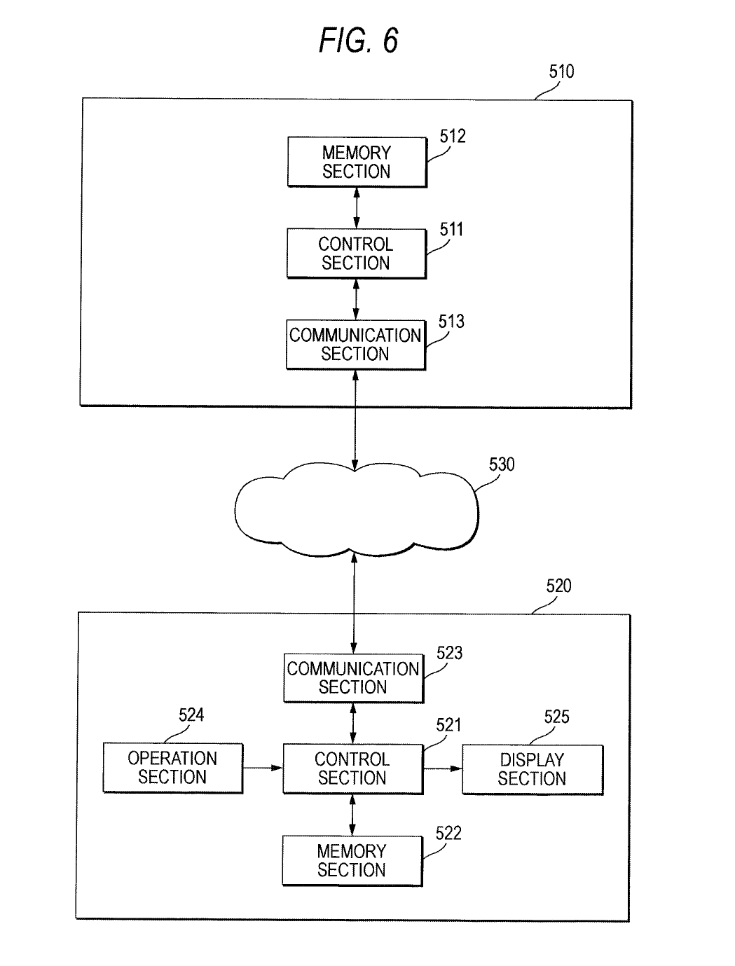

FIG. 6 is a general view showing a schematic configuration of a computer system containing a simulation apparatus for an image forming apparatus, according to a second exemplary embodiment of the invention.

As shown in FIG. 6, in the second exemplary embodiment, a simulation apparatus 510 and a user terminal 520 are connected via a communication network 530 so that the simulation apparatus 510 and the user terminal can perform data communication mutually. The communication network 530 may a wide area network such as the Internet or may be LAN (Local Area Network) such as a in-house intranet.

Here, the simulation apparatus 510 is a normal server computer, for example, and is configured to include a control section 511, a memory section 512 and a communication section 513. This simulation apparatus 510 functions as a simulation apparatus for an image forming apparatus. The simulation apparatus 510 simulates process that the image forming apparatus executes in accordance with a processing request transmitted from the user terminal 520, and outputs the simulation result to the user terminal 520.

As an example, the simulation apparatus 510 functions as a Web application server that generates Web page data in accordance with a request issued from the user terminal 520 and transmits the generated Web page data to the user terminal 520. More particularly, the simulation apparatus 510 arranges a user interface for prompting a user to input various information and information desired to present to a user as a simulation result to generate the web page data. Then, the simulation apparatus 510 transmits the generated web page data to the user terminal 520, executes the simulation and outputs the simulation result.

The control section 511 of the simulation apparatus 510 may be CPU, and operates based on a program stored the memory section 512. In the second exemplary embodiment, the control section 511 simulates the process that the image forming apparatus executes, based on the request issued from the user terminal 520. An example of the process that the control section 511 executes in the second exemplary embodiment will be described in detail later.

The memory section 512 may be a computer-readable storage medium that stores the program executed by the control section 511, and is configured to contain at least one of a memory device such as RAM and ROM and a disk device. Also, the memory section 512 operates as a working memory for the control section 511.

The communication section 513 may be a network card, for example, and transmits information via the communication network 530 in accordance with an instruction from the control section 511. Also, the communication section 513 receives information that comes in via the communication network 530 and outputs the received information to the control section 511.

Also, the user terminal 520 may be a personal computer, for example, and is configured to include a control section 521, a memory section 522, a communication section 523, an operation section 524, and a display section 525. The user can cause the simulation apparatus 510 to simulate the image forming apparatus by an instruction operation to the user terminal 520. Also, the user can confirm the result of simulation executed by the simulation apparatus 510 by looking at information displayed on the display section 525 of the user terminal 520.

As an example, if the simulation apparatus 510 functions as the Web application server, the user terminal 520 executes a Web browser program and causes the display section 525 to display data of a Web page that the simulation apparatus 510 outputs. Thus, the user can input into the Web page various information necessary for executing the simulation, and can check the result of simulation displayed on the Web page.

The control section 521 of the user terminal 520 may be CPU, and operates based on a program stored in the memory section 522. In the second exemplary embodiment, the control section 521 outputs a request for simulation execution to the simulation apparatus 510 in accordance with the user's instruction operation to the operation section 524. Also, the control section 521 receives the simulation result transmitted from the simulation apparatus 510, and causes the display section 525 to display the received result.

The memory section 522 may be a computer-readable storage medium that stores a program executed by the control section 521. The memory section 522 is configured to contain at least one of a memory device such as RAM or ROM and a disk device. Also, the memory section 522 operates as a working memory for the control section 521.

The communication section 523 may be a network card, for example, and transmits information via the communication network 530 in accordance with an instruction from the control section 521. Also, the communication section 523 receives incoming information via the communication network 530 and outputs the received information to the control section 521.

The operation section 524 may be a keyboard or a mouse, for example, and accepts the user's instructing operation and outputs contents of the instructing operation to the control section 521. The display section 525 may be a display, for example, and displays information in accordance with an instruction from the control section 521.

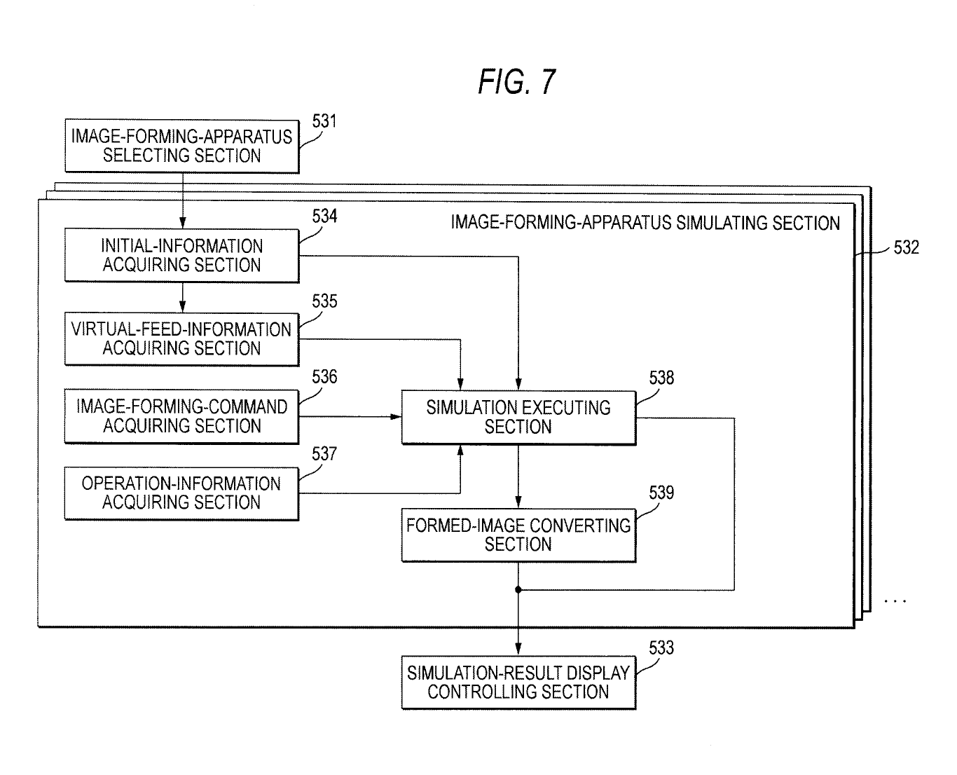

Next, functions that the simulation apparatus 510 performs in the second exemplary embodiment will be explained below. As shown in FIG. 7, the simulation apparatus 510 is configured to include functionally an image-forming-apparatus selecting section 531, an image-forming-apparatus simulating section 532, and a simulation-result display controlling section 533. These functions can be realized when the control section 511 executes the program stored in the memory section 512, for example. In this case, if plural types of image forming apparatuses whose simulation can be done by the simulation apparatus 510 are provided, plural image-forming-apparatus simulating sections 532 may be provided in association with the plural types of image forming apparatuses, respectively.

The image-forming-apparatus selecting section 531 selects an image forming apparatus as an object of simulation from the plural types of image forming apparatuses whose simulation can be done by the simulation apparatus 510, based on the user's instructing operation to the operation section 524 of the user terminal 520. Here, when the simulation apparatus 510 corresponds to only one type of image forming apparatus, the image-forming-apparatus selecting section 531 may be omitted.

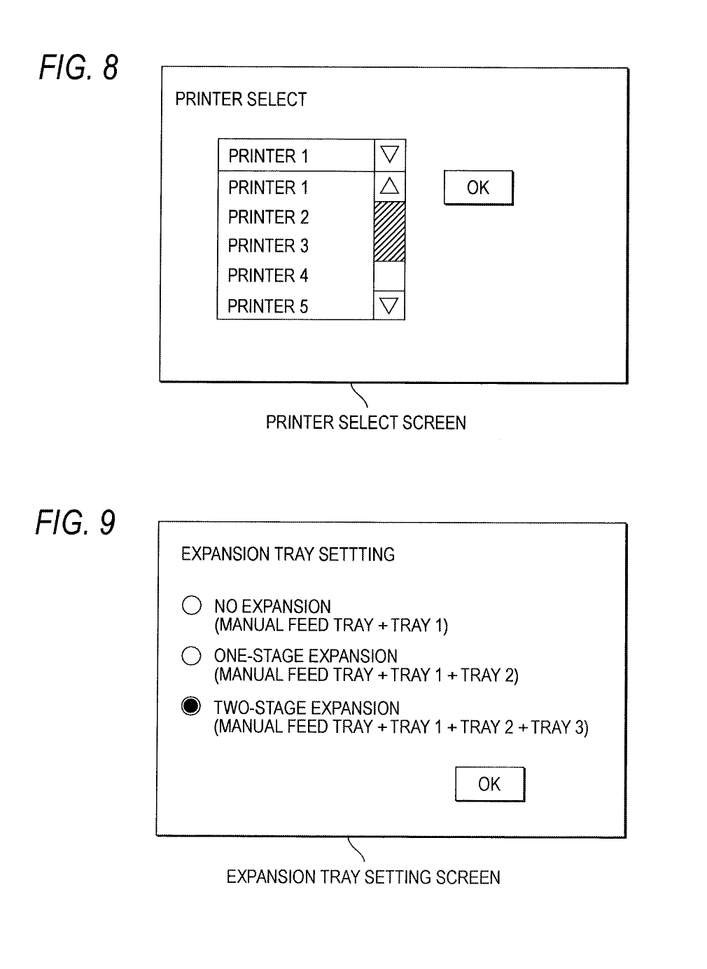

As an example, the image-forming-apparatus selecting section 531 outputs the Web page data representing a printer select screen shown in FIG. 8, and causes the display section 525 of the user terminal 520 to display this screen. When the user selects the image forming apparatus whose simulation is to be executed and presses an OK button on the screen, the user terminal 520 transmits information of the selected image forming apparatus to the simulation apparatus 510 via the communication network 530. The image-forming-apparatus selecting section 531 receives the information of the selected image forming apparatus, and decides the image forming apparatus, which is the object of simulation.

The image-forming-apparatus simulating section 532 simulates process that is executed by the image forming apparatus as the object of simulation. In this case, when plural image-forming-apparatus simulating sections 532 are provided, the respective image-forming-apparatus simulating sections 532 are associated with the particular types of image forming apparatuses as described above, and simulate the processes that are executed by the associated image forming apparatuses.

Here, details of functions that the image-forming-apparatus simulating section 532 realizes will be explained below. In subsequent explanation, it is assumed that the image forming apparatus, which is the object of simulation, simulated by the image-forming-apparatus simulating section 532 is an image forming apparatus P. The image-forming-apparatus simulating section 532 is configured to include an initial-information acquiring section 534, a virtual-feed-information acquiring section 535, an image-forming-command acquiring section 536, an operation-information acquiring section 537, a simulation executing section 538 and a formed-image converting section 539.

The initial-information acquiring section 534 acquires initial information regarding the image forming apparatus as preconditions upon executing the simulation. Specifically, the initial information are information (hardware information) relating to a hardware configurations such as an expansion tray mounted on the image forming apparatus P, for example.

As an example, the initial-information acquiring section 534 outputs Web page data representing an expansion tray setting screen shown in FIG. 9, and causes the display section 525 of the user terminal 520 to display the output Web page data on its screen. The user selects expansion-tray information representing a feed tray that he/she wants to add to the image forming apparatus P, and then presses an OK button on the screen. In response to this, the user terminal 520 transmits the selected expansion-tray information to the simulation apparatus 510 via the communication network 530. The image-forming-apparatus selecting section 531 receives the selected expansion-tray information, and then decides number and type of the feed tray that is provided to the image forming apparatus P, which is the object of simulation.

Also, the initial-information acquiring section 534 may acquire not only the expansion-tray information but also information relating to other hardware option such as information regarding a memory capacity of an expansion memory as hardware information. In addition, the initial-information acquiring section 534 may acquire information regarding version of a firmware that is installed into the image forming apparatus P, information (software information) regarding a software process that the image forming apparatus P executes, e.g., an initial set value that is to be set/registered into the image forming apparatus P.

The virtual-feed-information acquiring section 535 acquires information regarding a recording medium placed in the feed tray provided to the image forming apparatus P. Then, the virtual-feed-information acquiring section 535 stores this information in the memory section 512. For example, the virtual-feed-information acquiring section 535 acquires the number of feed paper recording media placed in the feed tray as the virtual feed information. Also, the virtual-feed-information acquiring section 535 may acquire information containing at least one of a size and a type of the recording media placed in the feed tray, as the virtual feed information. In addition, when the image forming apparatus P has plural feed trays, the virtual-feed-information acquiring section 535 may acquire information regarding recording media placed in respective feed trays, as the virtual feed information. In this case, the number and the type of feed trays provided to the image forming apparatus P can be decided based on the information regarding the feed trays, which are stored previously in the simulation apparatus 510 and provided to the image forming apparatus P in standard, and the expansion-tray information that the initial-information acquiring section 534 has acquired.

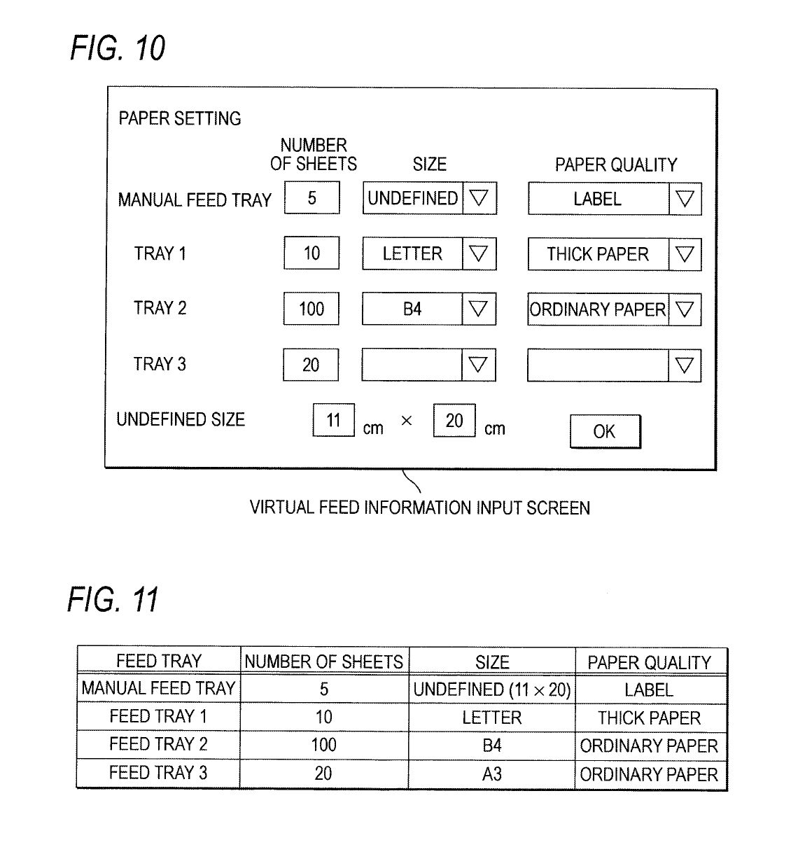

As a specific example, the virtual-feed-information acquiring section 535 causes the display section 525 of the user terminal 520 to display the virtual feed information as shown in FIG. 10. Then, when the user terminal 520 accepts information to be transmitted to the simulation apparatus 510 through a user's instructing operation to the operation section 524, the virtual-feed-information acquiring section 535 acquires the virtual feed information. Thus, the virtual-feed-information acquiring section 535 acquires the virtual feed information as given by a table shown in FIG. 11 as an example. In the example in FIG. 11, information about the number (number of sheets), size and type (paper quality) of recording media are provided to respective feed trays such as a manual feed tray, a feed tray 1, a feed tray 2 and a feed tray 3, as the virtual feed information.

The image-forming-command acquiring section 536 acquires an image forming command R containing information of an object image, which is an object of image formation by the image forming apparatus P. The image forming command is a control command described in PDL (Page Description Language), for example, and causes the image forming apparatus P to execute the image formation.

As a specific example, the image-forming-command acquiring section 536 acquires the image forming command R by a method described below.

As a first example, such an example will be explained below that when the user terminal 520 transmits the image forming command R generated on the user terminal 520 to the simulation apparatus 510 in accordance with the user's instructing operation to the operation section 524, the image-forming-command acquiring section 536 acquires the image forming command R. In this case, the user gets a printer driver program used to generate the image forming command R by downloading it from the Web server (or the simulation apparatus 510), for example, and installs the printer driver program into the user terminal 520. Then, the user causes the user terminal 520 to execute the application program and perform instructing operations to use the printer driver program and to execute the printing. Thus, the control section 521 of the user terminal 520 generates the image forming command R by executing the printer driver program. Then, the user executes the instructing operation to upload the image forming command R on the Web page displayed on the display section 525 by designating the generated image forming command R. Thus, the user terminal, 520 transmits the image forming command R to the simulation apparatus 510, and the image-forming-command acquiring section 536 receives and acquires the transmitted image forming command R.

According to this first example, since the user has to generate the image forming command R necessary for the simulation and then execute the instructing operation to upload, it may take much time and labor. Therefore, the user terminal 520 may transmit the image forming command R generated on the user terminal 520 to the simulation apparatus 510 as it is. This case will be explained below as a second example.

In the second example, like the first example, the user installs the printer driver program into the user terminal 520 and gives the printing instruction from the application program. The control section 521 of the user terminal 520 generates the image forming command R by executing the printer driver program, and outputs the generated image forming command R to a virtual printer port. The image forming command R output to the virtual printer port is transmitted to the simulation apparatus 510 via the communication network 530. Accordingly, the image-forming-command acquiring section 536 acquires the transmitted image forming command R.

In the first and second examples, the user gets the printer driver program and installs it into the user terminal 520. Thus, when the user executes on the user terminal 520 the same instructing operation as the case where the user causes actually the image forming apparatus P to form an image, the user can cause the simulation apparatus 510 to execute the simulation. However, in these examples, the user has to newly install the printer driver program into the user terminal 520 to do the simulation. It may take much time and labor. Therefore, for example, the user terminal 520 may transmit application data, which is generated by executing the application program based on the user's instructing operation, to the simulation apparatus 510 as it is. Then, the simulation apparatus 510 may generate the image forming command R. This case will be explained below as a third example.

In the third example, the user executes the instructing operation to upload the application data representing the image, which he/she wants to be the object of image formation by the image forming apparatus P, on the Web page displayed on the display section 525, for example. Accordingly, the user terminal 520 transmits the application data to the simulation apparatus 510. Upon receiving the application data, the control section 511 of the simulation apparatus 510 carries out a predetermined process in accordance with a type of the application data, and generates the image forming command R corresponding to the image forming apparatus P. Accordingly, the image-forming-command acquiring section 536 can acquire the image forming command R without user's labor. However, in this third example, the simulation apparatus 510 has to have an image forming command generating section for generating the image forming command R based on the application data by executing a predetermined process in accordance with the type of the application data the simulation of which the user wants to do.

According to any of the methods in the explained examples, the image-forming-command acquiring section 536 acquires the image forming command R, which is generated based on the application data being held by the user terminal 520. When the simulation executing section 538 executes the simulation based on the image forming command R, the user can cause the simulation apparatus 510 to execute the simulation by using the application data based on which the user wishes to cause the image forming apparatus P to form the image actually.

Also, the image-forming-command acquiring section 536 may make the memory section 512 store the acquired image forming command R. In this case, when the simulation is to be executed next time, the image-forming-command acquiring section 536 can acquire the image forming command R, which was used as the processed object in the previous simulation and stored in the memory section 512, in accordance with the user's instruction. As a result, when the simulation is conducted several times while changing the conditions such as the operating environment, the user's labor can be omitted. Otherwise, the image-forming-command acquiring section 536 may acquire predetermined sample data being stored in advance in the memory section 512 as the image forming command R, in accordance with the user's instruction.

Also, when the simulations of plural image informing apparatuses are to be carried out under such an assumption that plural image informing apparatuses have the same data format of the image forming command R, the image-forming-command acquiring section 536 contained in the other image-forming-apparatus simulating section 532 may acquire the image forming command R that the image-forming-command acquiring section 536 contained in one image-forming-apparatus simulating section 532 associated with a particular image informing apparatus have acquired, and then may use the command R in the simulation. As a result, if the user executes the instructing operation to transmit one image forming command R to the simulation apparatus 510, the user can execute respective simulations conducted in the case where the common image forming command R is transmitted to plural image forming apparatuses.

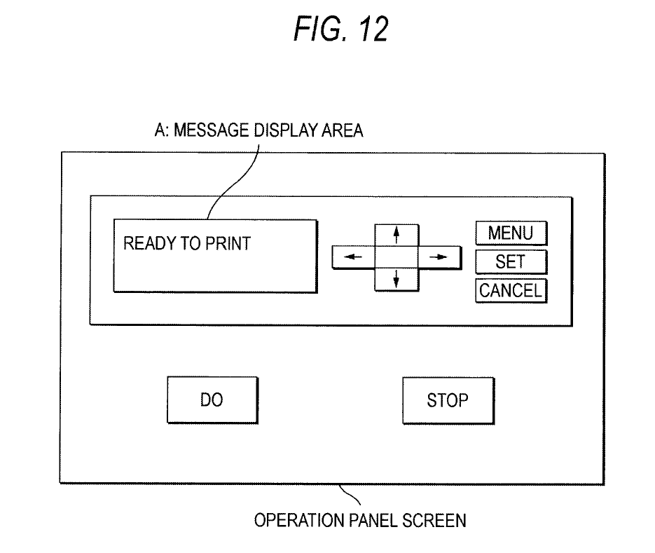

The operation-information acquiring section 537 acquires apparatus operating information representing the contents of the instructing operation that can be applied to the image forming apparatus P, based on the user's specification. Specifically, the image forming apparatus P is equipped with an operation panel, and the operation-information acquiring section 537 acquires the information representing the contents of the user's instructing operation to the operation panel as the apparatus operating information. In this case, the operation-information acquiring section 537 causes the display section 525 of the user terminal 520 to display an operation panel screen on which the operation panel is displayed in a simulation manner as shown in FIG. 12. Then, the operation-information acquiring section 537 acquires the apparatus operating information by accepting the information that the user terminal 520 transmits to the simulation apparatus 510 based on the user's instructing operation to the operation section 524. Accordingly, the user can execute in a simulation manner the instructing operation applied to the operation panel of the image forming apparatus P on the operation panel screen, while the simulation apparatus 510 can simulate the operation of the image forming apparatus P in accordance with the user's instructing operation to the operation panel.

In this case, the operation panel screen that the operation-information acquiring section 537 causes to display may contain a message display area A as shown in FIG. 12. The message display area A is an area that displays a displaying means such as a display, which is provided actually to the image forming apparatus P to, display various message information.

Also, when the image forming apparatus P has an operating unit other than the operation panel, the operation-information acquiring section 537 may cause the display section 525 of the user terminal 520 to display an input screen through which the user designates the executable instructing operation to such operating unit, and then may acquire the apparatus operating information based on the user's instructing operation applied to the input screen.

The simulation executing section 538 simulates the process that the image forming apparatus P executes, based on the initial information that the initial-information acquiring section 534 acquires, the virtual feed information that the virtual-feed-information acquiring section 535 acquires, the image forming command R that the image-forming-command acquiring section 536 acquires and the apparatus operating information that the operation-information acquiring section 537 acquires.

Specifically, the simulation executing section 538 executes the simulation as follows. First, the simulation executing section 538 decides operating environment of the image forming apparatus P, based on the information relating to the image forming apparatus P, which is stored in advance in the memory section 512 of the simulation apparatus 510, and the initial information that the initial-information acquiring section 534 acquires. Then, the simulation executing section 538 simulates the process that the image forming apparatus P executes when the user's instructing operation is applied to the operation panel or when the image-forming-command acquiring section 536 receives the image forming command R under the above operating environment, based on the image forming command R and the apparatus operating information that the operation-information acquiring section 537 acquires. As the result, the simulation executing section 538 outputs various expected information that the image forming apparatus P presents to the user by displaying on the operation panel, to the simulation-result display controlling section 533.

In particular, in the second exemplary embodiment, the simulation executing section 538 simulates the feed process (feed simulation process) that the image forming apparatus P executes in accordance with the recording medium placed in the feed tray. Details of the feed process that the image forming apparatus P executes and the feed simulation process that the simulation executing section 538 executes will be explained later.

Also, the simulation executing section 538 may generate formed image data representing expected formed-image data that the image forming apparatus P is expected to form on the fed recording medium, based on the virtual feed information and the image forming command R in a situation that the recording medium specified by the virtual feed information is fed to the image forming apparatus P. Then, the simulation executing section 538 may output the formed image data to the formed-image converting section 539. As a specific example, first the simulation executing section 538 simulates the image process that the image forming apparatus P performs on the image data, which is the object image contained in the image forming command R, to thereby generate output image data that the image forming apparatus P outputs to an image forming unit provided to the image forming apparatus P. For example, when the image forming apparatus P has the image forming unit that forms an image on a recording medium with four color toners of cyan (C), magenta (M), yellow (Y), and black (K), the output image data is image data that represented by four component colors of CMYK obtained by applying the color converting process to the image data of the object image in light of the gradation characteristic of the image forming unit.

Then, the simulation executing section 538 generates the formed image data representing the image formed on the fed recording medium, based on the output image data and the size and/or type of the recording medium specified by the virtual feed information. For example, when the size of the fed recording medium is smaller than the size of the output image data, the simulation executing section 538 defines an image area having a size, which is determined based on the size of the fed recording medium, with respect to the output image data and extracts the defined image area, to thereby generate the formed image data. As a result, when the image forming apparatus P forms an image on a recording medium whose size does not coincide with a size of output image data as it is because feed tray contained in the image forming command R is erroneously specified, the user can check beforehand what operation the image forming apparatus P will execute and consequently what image will be formed on the output recording medium in a condition that the image forming apparatus P is not actually provided.

The formed-image converting section 539 converts the formed image data generated by the simulation executing section 538 into image data in a predetermined data format such as a bitmap format, for example, that can be displayed on the display section 525 of the user terminal 520. Then, the formed-image converting section 539 outputs the converted data to the simulation-result display controlling section 533.

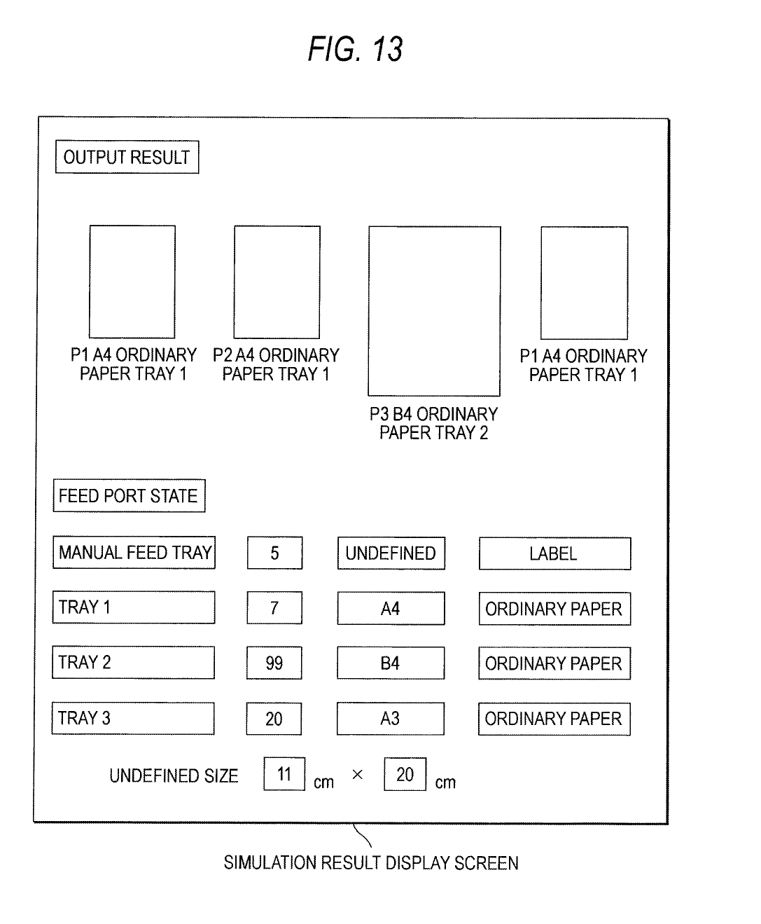

The simulation-result display controlling section 533 outputs the data, which the image-forming-apparatus simulating section 532 in the image forming apparatus selected by the image-forming-apparatus selecting section 531 outputs as the simulation result, as the Web page data, and thus executes the display controlling process displayed on the display section 525 of the user terminal 520. As the data acting as the object of the display controlling process, there are the formed image data converted by the formed-image converting section 539, for example. The contents of the virtual feed information, which are updated by the simulation executing section 538 in accordance with a consumption of the recording medium by the image forming process, may be contained in the data acting as the object of the display controlling process. Thus, the user can check the simulation result on the screen of the user terminal 520. As an example, the simulation-result display controlling section 533 causes the display section 525 of the user terminal 520 to display a simulation result display screen that displays the formed image data (output result) and contents of the virtual feed information (feed port condition), as shown in FIG. 13.

Also, the simulation-result display controlling section 533 may display message information such as recording medium related information, which is expected to be displayed on the display contained in the operation panel of the image forming apparatus P, for example, on the message display area A on the operation panel screen as shown in above FIG. 12. Accordingly, the user can check the recording medium related information, in a manner similar to that in which the image forming apparatus P actually offers the information to the user. Also, the simulation-result display controlling section 533 may display information, which the image forming apparatus P is expected to cause the display section 525 of the user terminal 520 to display as the pop-up message, among the recording medium related information in a predetermined area of the simulation result display screen, to thereby offer the information to the user.

Then, a specific example of the feed simulation process that the simulation executing section 538 executes will be explained below.

First, the feed process that the image forming apparatus P, which is the object of simulation executed by the simulation executing section 538, will be explained below. Here, it is assumed that the feed process executed upon applying the image forming process to an object image I contained in the image forming command R.

The image forming apparatus P specifies a necessary recording medium required to form the object image I based on the image forming command R. For example, the image forming apparatus P specifies the size and the type of the necessary recording medium, based on the specification of the size of the object image I and the size and the type of the available recording medium contained in the image forming command R.

Then, the image forming apparatus P selects a feed tray from which a recording medium on which the object image I is formed is fed. For example, the image forming apparatus P selects the feed tray based on the feed tray specification contained in the image forming command R. Otherwise, in some cases, the image forming apparatus P may select the feed tray based on the specified necessary recording medium and information regarding a recording medium that has been fed to the feed tray. In this case, when the information regarding the size and the type of the recording medium placed on the feed tray is specified in advance on the operation panel, for example, the image forming apparatus P specifies and selects a feed tray in which the necessary recording medium is placed, based on related information. Also, when a sensor provided to the feed tray can specify a type or size of a recording medium placed in at least a part of feed trays provided to the image forming apparatus P can be specified, the image forming apparatus P may specify and select a feed tray in which the necessary recording medium is placed based on the size and the type of the recording medium specified by the sensor.

Here, when the number of the necessary recording media required to form all the object images I contained in the image forming command R is smaller than the number of the recording media placed in the feed tray, such a situation occur that no recording medium is placed in the specified feed tray in the middle of the image forming process according to the image forming command R. In this case, the image forming apparatus P informs the user of that effect, and also outputs the recording medium relating information that calls upon the user to supplement the recording medium by displaying the recording medium relating information on a displaying unit such as the display. For example, the image forming apparatus P causes the display arranged on the operation panel to display a message that “please supplement paper tray 1 A4 ordinary paper” as the recording medium relating information. In response to this, the user may place recording media on the feed tray or executes an instructing operation to stop the image forming process by canceling the image forming command R.

Also, such a situation may be brought about that the recording medium placed in the feed tray does not coincide with the necessary recording medium in type or size. That is, no necessary recording medium is placed in the feed tray. In this case, similarly the image forming apparatus P informs the user of that effect, and outputs the recording medium relating information that calls upon the user to supplement the necessary recording medium.

In particular, if no sensor is provided to a part of trays such as a manual feed tray among the feed trays provided to the image forming apparatus P, the image forming apparatus P cannot specify the type and the size of the recording medium placed in the manual feed tray even though the recording medium whose type and size coincide with those of the necessary recording medium is placed in a manual feed tray. As a result, in some cases, the image forming apparatus P would output the recording medium relating information that calls upon the user to supplement the necessary recording medium. Also, when the recording medium is placed in the feed tray equipped with no sensor, some image forming apparatuses output the recording medium relating information that calls upon the user to set the type or the size the fed recording medium and cause the user to input the type and the size of the fed recording medium.

In contrast, when a recording medium whose type and size coincide with those of the necessary recording medium is placed in the selected feed tray, or when it is not decided whether or not the necessary recording medium and the recording medium placed in the selected feed tray coincide in type and size with each other, the image forming apparatus P feeds the recording medium from the selected feed tray and then forms the image on the fed recording medium.

The simulation executing section 538 executes the simulation of the feed process by the image forming apparatus P as described above. That is, the simulation executing section 538 specifies the necessary recording medium based on the image forming command R that the image-forming-command acquiring section 536 acquires. Then, the simulation executing section 538 outputs to the simulation-result display controlling section 533 the recording medium relating information, which is expected to be output when the image forming apparatus P acquires the image forming command R while a recording medium specified by the virtual feed information is fed, based on the specified necessary recording medium and the virtual feed information.

Also, when it is supposed that the image forming apparatus P will feed a recording medium from a feed tray in the feed process, the virtual feed information is updated to reduce the number of feed paper recording media that are fed to the feed trays selected as the feeding object. Accordingly, the virtual feed information derived after the simulation executing section 538 executes the simulation of the feed process in accordance with the image forming command R indicates the number of expected feed paper recoding media, which is still left in the feed tray after the image forming apparatus P executed the feed process.

In addition, the simulation executing section 538 may update the virtual feed information based on information that the virtual-feed-information acquiring section 535 acquires during the execution of simulation in accordance with the user's instructing operation. In this case, the simulation executing section 538 can simulate the operation of the image forming apparatus P when the user supplements the recording medium to the feed tray during the execution of the image forming process, based on the updated virtual feed information. As a result, when the recording medium relating information indicating that a recording medium should be supplied to the feed tray is output, the user can confirm the operation of the image forming apparatus P when the recording medium is supplied to the feed tray during the image forming process by updating the virtual feed information, in place of actually supplementing the recording medium to the feed tray of the image forming apparatus P.

Also, the simulation executing section 538 may simulate the operation of the image forming apparatus P when the instructing operation represented by apparatus operating information is applied to the image forming apparatus P, based on the apparatus operating information that the operation-information acquiring section 537 acquires in accordance with the user's instructing operation during the execution of simulation. Accordingly, in the case where the recording medium relating information to request the user to supply the necessary recording medium to the feed tray is output, the user can check the operation of the image forming apparatus P taken when the user executes the process of canceling the image forming command R by inputting the instructing operation to the operation panel.

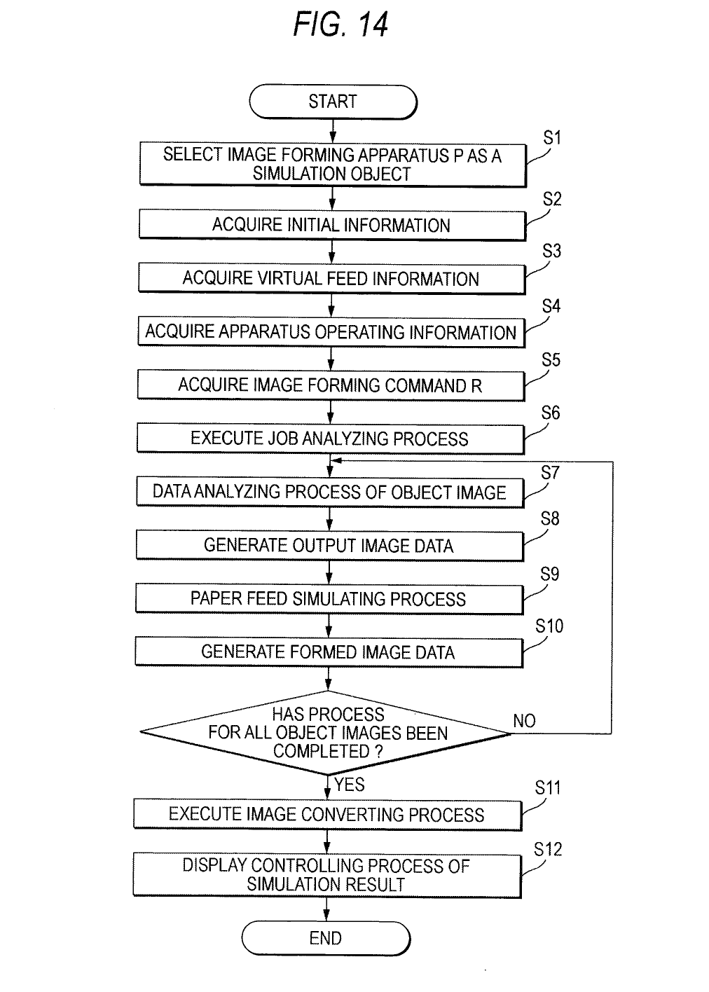

Next, an example of an overall flow of the process executed when the simulation apparatus 510 executes the simulation in this exemplary embodiment will be explained with reference to a flowchart shown in FIG. 14 below.

First, the image-forming-apparatus selecting section 531 selects the image forming apparatus P as the object of simulation (S1). Then, the initial-information acquiring section 534 of the image-forming-apparatus simulating section 532 corresponding to the image forming apparatus P acquires the initial information relating to the image forming apparatus P (S2). In particular, the initial-information acquiring section 534 acquires the expansion-tray information, and decides the number and the type of the feed tray of the image forming apparatus P.

Then, the virtual-feed-information acquiring section 535 acquires the information relating to the recording media placed in the respective feed trays decided by the process in S2, as the virtual feed information (S3). The user may execute instructing operation for specifying the type and the size of the recording media placed in the feed trays to the image forming apparatus P, through the operation panel screen. Thus, the operation-information acquiring section 537 acquires the apparatus operating information relating to the type and the size of the recording media placed in the feed trays (S4).

Subsequently, the image-forming-command acquiring section 536 acquires the image forming command R (S5). Thus, the simulation executing section 538 starts to simulate the image forming process that the image forming apparatus P executes. In this case, the image-forming-command acquiring section 536 may acquire plural image forming commands R. Also, the simulation executing section 538 may start the simulation in accordance with the user's instructing operation to instruct the start of the simulation after the image-forming-command acquiring section 536 acquires the image forming command R.

The simulation executing section 538 first applies job analyzing process to a portion, which is described in a job control language and contained in the image forming command R (S6). Then, the simulation executing section 538 applies following processes to respective object images contained in the image forming command R. More particularly, the simulation executing section 538 first executes data analyzing process based on information of the object image, which is contained in the image forming command R (S7). Then, the simulation executing section 538 generates output image data by executing image drawing process based on the analyzed result of the process in S7 (S8).

Then, the simulation executing section 538 executes feed simulating process for the feed process that the image forming apparatus P executes when the output image data obtained by the process in S8 is formed (S9). Also, the simulation executing section 538 generates the formed image data representing an image formed on the recording medium, based on the output image data generated by the process in S8 and the result of the feed simulation process in S9 (S10).

The simulation executing section 538 applies processes in S7 to S10 repeatedly to all object images contained in the acquired image forming command R. When the simulation of the image forming process of all object images has been completed, the process goes to the process in S11.

Then, the formed-image converting section 539 executes an image converting process to convert the formed image data generated by the process in S10 into an image in a predetermined data format (S11). Then, the simulation-result display controlling section 533 executes a display controlling process to cause the display section 525 of the user terminal 520 to display the simulation result (S12). As a specific example, the simulation-result display controlling section 533 causes the display section 525 to display the converted formed image data obtained as the result of the process in S10 and the information represented by the virtual feed information at a point of time the simulation is ended and concerning the recording medium fed to the image forming apparatus P.

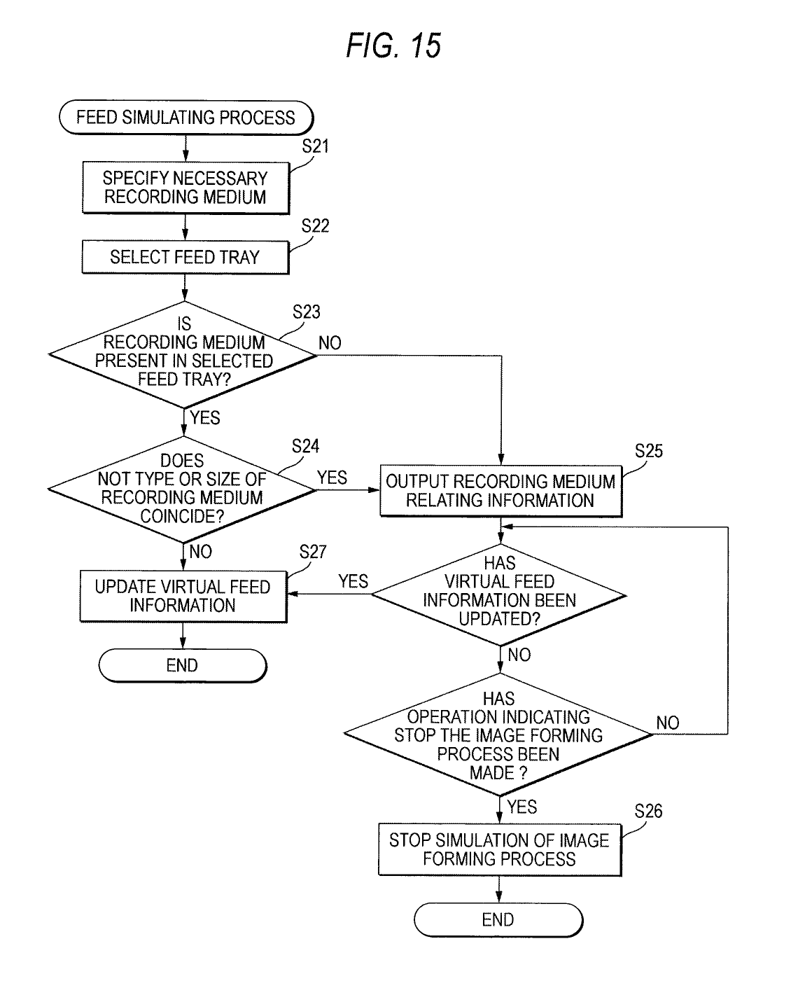

Next, an example of the feed simulation process in S9 in FIG. 14 will be explained with reference to a flowchart shown in FIG. 15 below.

The simulation executing section 538 first specifies a necessary recording medium required to form the object image, based on the image forming command R (S21). Then, the simulation executing section 538 selects a feed tray from which the recording medium is fed, by a method corresponding to a method that the image forming apparatus P executes (S22).

Subsequently, the simulation executing section 538 decides whether or not a recording medium is present in the feed tray selected by the process in S22, by referring to the virtual feed information held in the memory section 512 (S23). If the feed recording medium is present in the selected feed tray, the simulation executing section 538 decides whether the recording medium placed in the selected feed tray does not coincide in type or size with the necessary recording medium specified by the process in S21 (S24). Here, it is assumed that the image forming apparatus P can discriminate at least one of the type and the size of the recording medium placed in the feed tray by a sensor.

When it is decided by the process in S23 that no recording medium is present in the selected feed tray or it is decided by the process in S24 that the recording medium placed in the selected feed tray does not coincide in type or size with the necessary recording medium, the simulation executing section 538 outputs a predetermined recording medium relating information to the simulation-result display controlling section 533 (S25). Then, the simulation executing section 538 waits for the user's instructing operation responding to the above output. Then, when the virtual-feed-information acquiring section 535 acquires the virtual feed information, which indicates that the necessary recording medium is placed in the feed tray, by the user's instructing operation and then updates the virtual feed information stored in the memory section 512, the simulation executing section 538 continues the process based on the updated virtual feed information. In contrast, when the operation-information acquiring section 537 acquires the apparatus operating information corresponding to the instructing operation, which requests to stop the image forming process executed in response to the image forming command R, by the user's instructing operation, the simulation executing section 538 stops the simulation of the image forming process (S26). Then, the process is ended.

When it is not decided by the process in S24 that the recording medium does not coincide in type or size with the necessary recording medium or updating of the virtual feed information in response to the output of the recording medium relating information in S25 is performed, the simulation executing section 538 updates the virtual feed information to decrease the number of ̂recording media placed in the selected feed tray by one in response to the feeding of the recording medium executed by the image forming apparatus P (S27). Then, the feed paper simulating process is ended.

In this case, a flow of the above feed paper simulating process is shown by way of example. Depending on the operating conditions, for example, whether or not the image forming apparatus can acquire the information concerning the type and the size of the recording medium placed in the feed tray, etc., the contents of the processes that the simulation executing section 538 executes may be differentiated.

According to this exemplary embodiment explained above, the operation of the image forming apparatus corresponding to the fed recording medium can be simulated based on the virtual feed information. Therefore, the user can know the expected error message output at a time of user's actual use or the information relating the operability such as the set items that are input by the user, and the like even in a situation that the image forming apparatus is not present. Also, the user can execute the simulation of the image formation while changing expansion-tray information, and the like from those of the image forming apparatus that is being used now after such user purchased the image forming apparatus. Therefore, the user can know a change in the operation in the image forming apparatus caused by an expansion of hardware without actual change of the hardware of the image forming apparatus.

Also, the invention is not limited to the above embodiments, and can be accomplished by various embodiments. For example, in the above explanation, the user applies the instructing operation to the user terminal 520 provided separately from the simulation apparatus 510 or checks the simulation result from the user terminal 520. In this case, the function of the simulation apparatus 510 and the function of the user terminal 520 may be realized on one computer. Alternately, the function of the simulation apparatus 510 may be realized by a cooperation of plural computers. For example, the simulation apparatus for the image forming apparatus according to the embodiment of the invention may be constructed by a front-end server that executes the output of the Web page displayed on the user terminal 520 and the reception of the information transmitted from the user terminal 520, and a back-end server that simulates the processes that the image forming apparatus executes.

What is claimed is:

1. A simulation apparatus for simulating a process executed by an image forming apparatus, the simulation apparatus comprising:
a first acquiring unit that acquires an image formation command comprising information of a target image;
an image generating unit that generates an image, which is expected to be output by the image forming apparatus, based on the acquired image formation command; and
a first output unit that coverts the generated image into data in a predetermined format, the first output unit that outputs the converted data.

2. The apparatus according to claim 1, wherein:
the image formation command comprises model specification information that specifies a model of the image forming apparatus, and
the image generating unit generates the image, which is expected to be output by the image forming apparatus when the image forming apparatus of the model specified by the model specification information included in the image formation command receives the image formation command.

3. The apparatus according to claim 1, further comprising:
a second acquiring unit that acquires information relating to a feed recording medium placed on a feed paper tray of the image forming apparatus, as virtual feed information;
a specifying unit that specifies a recording medium, which is required when the image forming apparatus forms the target image, based on the acquired image formation command; and
a display unit that displays a result of a simulation.

4. The apparatus according to claim 3, further comprising:
a third acquiring unit that acquires operation information representing details of instruction operation, which can be executed with respect to the image forming apparatus, based on a user's specification, wherein:
the second output unit outputs the information relating to the recording medium, the information which is expected to be output when the instruction operation is executed with respect to the image forming apparatus, based on the operation information.

5. The apparatus according to claim 3, wherein:
the second acquiring unit acquires information comprising number of the recording medium placed on the feed tray of the image forming apparatus, as the virtual feed information, and
the second output unit outputs the information relating to the recording medium, the information which is expected to be output by the image forming apparatus when number of the specified recording medium is less than the number of the placed recording medium.

6. The apparatus according to claim 3, wherein:
the second acquiring unit acquires at least one of a kind and a size of the recording medium placed on the feed tray of the image forming apparatus, as the virtual feed information, and
the second output unit outputs the information relating to the recording medium, the information which is expected to be output by the image forming apparatus when the specified recording medium is different in at least one of a kind and a size from the recording medium placed on the feed tray of the image forming apparatus.

7. The apparatus according to claim 3, wherein the image generating unit generates the image, which is expected to be formed on the recording medium fed from the feed tray by the image forming apparatus, based on the virtual feed information and the image formation command.

8. A simulation system comprising:
the simulation apparatus according to claim 1; and
a display unit that displays an operation screen in accordance with the image forming apparatus, wherein:
the first acquiring unit acquires the image formation command based on information input through the displayed operation screen.

9. The system according to claim 8, wherein:
the image formation command comprises model specification information that specifies a model of the image forming apparatus, and
the image generating unit generates the image, which is expected to be output by the image forming apparatus when the image forming apparatus of the model specified by the model specification information included in the image formation command receives the image formation command.

10. The system according to claim 8, further comprising:
a command generating unit that generates the image forming command based on the information input through the displayed operation screen, wherein:
the first acquiring unit acquires the image formation command generated by the command generating unit.

11. A simulation system comprising:
the simulation apparatus according to claim 1;
a display unit that displays an operation screen in accordance with the image forming apparatus;
a client device; and
a server device, wherein:
the first acquiring unit acquires the image formation command based on information input through the displayed operation screen,
the client device comprises the display unit,
the display unit displays the operation screen by means of a web browser,
the server device comprises the first acquiring unit, the image generating unit and the first output unit,
the first acquiring unit acquires the image forming command based on the information input through the operation screen displayed by the web browser, and
the first output unit outputs the generated image to the web browser.

12. A method for simulating a process executed by an image forming apparatus, the method comprising:
acquiring an image formation command comprising information of a target image;
generating an image, which is expected to be output by the image forming apparatus, based on the acquired image formation command;
converting the generated image into data in a predetermined format; and
outputting the converted data.

13. A computer readable medium storing a program causing a computer to execute a process for simulating a process executed by an image forming apparatus, the process executed by the computer comprising:
acquiring an image formation command comprising information of a target image;
generating an image, which is expected to be output by the image forming apparatus, based on the acquired image formation command;
converting the generated image into data in a predetermined format; and
outputting the converted data.

14. A computer data signal embodied in a carrier wave for enabling a computer to execute a process for simulating a process executed by an image forming apparatus, the process executed by the computer comprising:
acquiring an image formation command comprising information of a target image;
generating an image, which is expected to be output by the image forming apparatus, based on the acquired image formation command;
converting the generated image into data in a predetermined format; and
outputting the converted data.
